(19) United States
(12) Patent Application Publication
(10) Pub. No.: US 2026/0170401 A1
(43) Pub. Date: Jun. 18, 2026

(54) AUTONOMOUS MACHINE LEARNING COMPUTATION AND STORAGE NODE

(71) Applicant: INTERNATIONAL BUSINESS MACHINES CORPORATION, Armonk, NY (US)

(72) Inventors: Krishna Thangaraj, San Jose, CA (US); Brent William Yardley, Hillsboro, OR (US)

(21) Appl. No.: 18/984,382

(22) Filed: Dec. 17, 2024

(51) Int. Cl. G06N 20/00; H04L 67/104

(52) U.S. Cl. CPC G06N 20/00; H04L 67/104

(57) ABSTRACT

A system for machine learning includes a host processor and a machine learning storage node coupled to the host processor. The machine learning storage node includes a node controller, a nonvolatile storage medium, one or more machine learning processors dedicated for performing machine learning operations, and a communication bus that is coupled to the node controller, the nonvolatile storage medium, and the one or more machine learning processors. The one or more machine learning processors operate under control of the node controller to perform the machine learning operations using data accessed from the nonvolatile storage medium. The node controller is capable of controlling operation of the one or more machine learning processors responsive to commands from the host processor.

### BACKGROUND

This disclosure relates to artificial intelligence (AI), and, more particularly, to computer hardware topologies supporting self-contained computation and data storage to facilitate machine learning.

Machine learning is typically identified as an especially significant branch of AI. Language translation, sentiment analysis, information extraction, image and speech recognition, and autonomous driving are only some of the many practical applications of machine learning. AI-enabled chatbots and other generative AI applications, for example, typically employ transformers which are variants of neural networks, which are a type of machine learning. A common thread of the different techniques and various applications of machine learning is a machine that is capable of learning from data how to perform a given task. Regardless of the task, the success of any machine learning endeavor turns largely on the quantity of data available for training a machine learning model to perform the task.

### SUMMARY

In one or more embodiments a machine learning system includes a host processor and a machine learning storage node coupled to the host processor. The machine learning storage node includes a node controller, a nonvolatile storage medium, one or more machine learning processors dedicated for performing machine learning operations, and a communication bus that is coupled to the node controller, the nonvolatile storage medium, and the one or more machine learning processors. The one or more machine learning processors operate under control of the node controller to perform the machine learning operations using data accessed from the nonvolatile storage medium. The node controller is capable of controlling operation of the one or more machine learning processors responsive to commands from the host processor.

In one or more embodiments, a machine learning device includes a node controller, a nonvolatile storage medium, one or more machine learning processors dedicated for performing machine learning operations, and a communication bus coupled to the node controller, the nonvolatile storage medium, and the one or more machine learning processors. The one or more machine learning processors operate under control of the node controller to perform the machine learning operations using data accessed from the nonvolatile storage medium.

In one or more embodiments, a computer-based method of performing machine learning by a machine learning storage node is disclosed. The method includes storing machine learning data within a nonvolatile storage of the machine learning storage node. The machine learning storage node includes a node controller and one or more machine learning processors. The method further includes executing, under the control of the node controller, machine learning operations by the one or more machine learning processors using data accessed from the nonvolatile storage medium. The one or more machine learning processors are dedicated to performing the machine learning operations.

This Summary section is provided merely to introduce certain concepts and not to identify any key or essential features of the claimed subject matter. Many other features and embodiments of the invention will be apparent from the accompanying drawings and from the following detailed description.

### BRIEF DESCRIPTION OF THE DRAWINGS

The accompanying drawings show one or more embodiments; however, the accompanying drawings should not be taken to limit the invention to only the embodiments shown. Various aspects and advantages will become apparent upon review of the following detailed description and upon reference to the drawings.

FIG. 1 illustrates an example architecture of an autonomous machine learning storage node (AMLSN).

FIG. 2 illustrates another example architecture of an AMLSN.

FIG. 3 illustrates an example system in which components of a data processing system operate in conjunction with a plurality of solid-state drives and the AMLSN of FIG. 1.

FIG. 4 illustrates an example system in which components a data processing system operate in conjunction with a plurality of solid-state drives and multiple AMLSNs.

FIGS. 5A, 5B, and 5C illustrate an example of combined machine learning and inferencing using components of a data processing system operating in conjunction with a plurality of solid-state drives and multiple AMLSNs.

FIG. 6 illustrates an example of a composable deep neural network comprising a cluster of AMLSNs communicatively coupled with one another.

FIG. 7 illustrates a method of performing machine learning processing and data storage using the AMLSN of FIG. 1.

FIG. 8 illustrates an example implementation of a data processing system for use in conjunction with the AMLSN of FIG. 1.

FIG. 9 illustrates an example of a computing environment that is capable of implementing machine learning operation the AMLSN of FIG. 1.

### DETAILED DESCRIPTION

While the disclosure concludes with claims defining novel features, it is believed that the various features described herein will be better understood from consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to Artificial Intelligence (AI), and, more particularly, to computer hardware topologies supporting self-contained computation and data storage to facilitate machine learning. Notwithstanding technological advances such as generative AI, deep neural networks, and various other types of machine learning, challenges remain. Given the extremely large quantities of data that must be processed in implementing various machine learning models, a significant challenge is the so-called “memory bottleneck” problem. Memory bottleneck refers to constraints arising as a result of limited speed with which data is transferred between random-access memory (RAM) and a processing unit, such as a central processing unit (CPU), graphical processing unit (GPU), neural processing unit (NPU), or other type of processing unit. The problem, moreover, encompasses bottlenecks between processors performing machine learning and data storage or memory at various hierarchical levels, including RAM, nonvolatile storage media, and caches, which impede, or pose bottlenecks, in getting data into and out of a processing unit. The typically huge quantity of data that must be processed to successfully train and use a machine learning model not only imposes a significant processing burden but may severely exacerbate the memory bottleneck problem.

In accordance with the inventive arrangements disclosed herein, systems, devices, and methods are provided that are capable of autonomously performing machine learning operations, including operations for training various machine learning models and using the trained models to generate inferences and predictions (e.g., regressions and classifications). As used herein, “autonomous” means that all or a significant portion of the machine learning operations related to both training and inferencing are performed without using a host data processing system's processor(s) or memory. With the inventive arrangements disclosed herein, machine learning operations are performed by a computational storage node capable not only of processing data but also storing data in both volatile memory and nonvolatile storage media.

The inventive arrangements include an autonomous machine learning storage node (AMLSN) capable autonomously performing machine learning operations using a nonvolatile storage medium. The autonomous processing eases or altogether eliminates the processing burden on a data processing system's processor and mitigates the memory bottleneck problem. An AMLSN may include an internal bus connecting a controller with one or more machine learning processors (e.g., analog crossbar memories and/or other processors) and with a nonvolatile storage medium (e.g., NAND flash arrays). The inventive arrangements mitigate or eliminate memory bottlenecks with respect to the internal bus of the AMLSN. In certain arrangements, data for performing a machine learning task is transferred between an AMLSN and one or more solid-state drives connected via a system bus. AMLSN consumes data received from one or more solid-state drives. In some embodiments, AMLSN may also convey data to the one or more solid-state drives, such as regression values or classifications, while persistently storing data such as model parameters and processor-executable instructions for performing other machine learning tasks. Regardless, only the system bus of the host system is utilized for machine learning; there is little, or no demand imposed on the host system's processing unit or memory. An additional aspect of the AMLSN is composability. Composability allows deep neural networks to be built by clustering multiple AMLSNs. With composability, the deep neural network is easily scaled up or modified simply by adding additional AMLSNs to the cluster, wherein the AMLSNs form the deep neural network.

Further aspects of the inventive arrangements are described below in greater detail with reference to the figures. For purposes of simplicity and clarity of illustration, elements shown in the figures are not necessarily drawn to scale. For example, the dimensions of some of the elements may be exaggerated relative to other elements for clarity. Further, where considered appropriate, reference numbers are repeated among the figures to indicate corresponding, analogous, or like features.

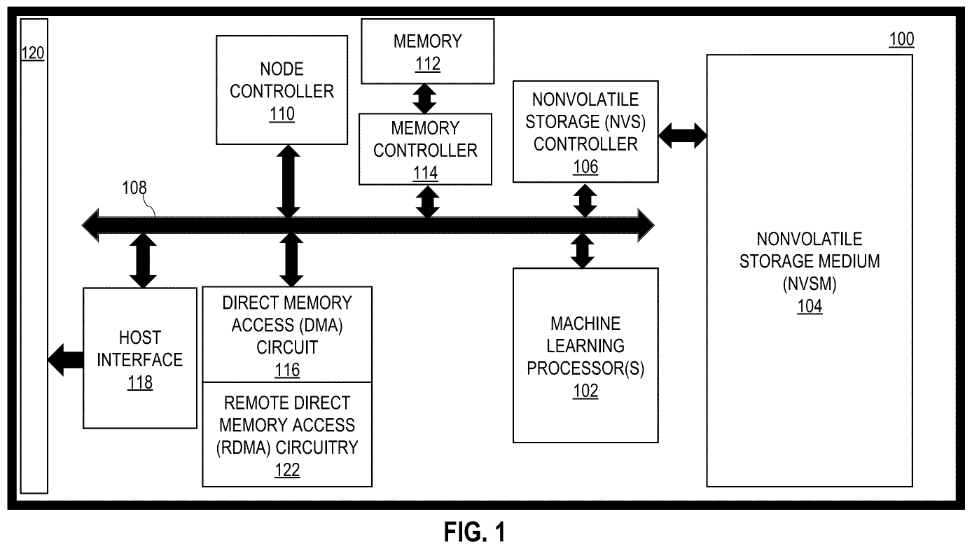

FIG. 1 illustrates an example architecture of an autonomous machine learning storage node (AMLSN) 100, according to certain embodiments. Illustratively, AMLSN 100 includes one or more machine learning (ML) processors 102, nonvolatile storage medium 104, nonvolatile storage (NVS) controller 106, communication bus 108, node controller 110, memory 112, memory controller 114, direct memory access circuit 116, host interface 118, drive connector 120, and optional remote direct memory access (RDMA) circuitry 122. Operatively, ML processor(s) 102 operate under the control of node controller 110 to perform the machine learning operations. The machine learning operations may use data accessed from the nonvolatile storage medium 104. The data accessed may include processor-executable instructions specific to a particular machine learning model and/or previously generated machine learning model parameters. The model parameters may have been previously generated by machine learning operations performed by ML processor(s) 102 and written to nonvolatile storage medium 104 for persistent storage.

ML processor(s) 102 are capable of performing one or more machine learning operations for training a machine learning model (e.g., deep neural network) and/or operations for generating inferences (e.g., regressions, classifications) with a trained machine learning model. ML processor(s) 102, in certain embodiments, may be implemented using one or more analog crossbar memories for performing operations such as matrix-vector multiplications, matrix inversions, generation of pseudoinverses, and/or generation of eigenvectors and corresponding eigenvalues. These operations are used extensively in training and generating inferences with deep neural networks and generative AI models, as well as linear regressions, logistic regressions, support vector machines (SVRs) and other machine machining learning models. Performing such operations, ML processor(s) 102 are capable of training and generating inferences and predictions with deep neural networks, generative AI models, and other machine learning models. In one or more embodiments, ML processor(s) 102 may comprise an NPU, GPU, CPU, digital signal processor (DSP), application-specific integrated circuit (ASIC), or other type of processing unit. In one or more embodiments, ML processor(s) 102 are reserved for, or dedicated to, exclusively performing ML operations.

Nonvolatile storage medium 104 is capable of persistently storing data including machine learning data used or generated by ML processor(s) 102 in performing the various machine learning operations. As used herein, “machine learning data” means data specifically input to or generated as an output of ML processor(s) 102 in performing one or more machine learning operations. Machine learning data may be instruction data causing ML processor(s) 102 to perform a specific machine learning operation in training a machine learning model or in generating an inference with a trained machine learning model. For example, machine learning data may instruct ML processor(s) 102 to perform a matrix-vector multiplication as part of training a deep neural network or generating an inference with the deep learning neural network. Machine learning data also includes specific values of machine learning model parameters. For example, in performing the matrix-vector multiplication for training or inferencing with the deep neural network, machine learning data may be values of the matrix elements, or “weights,” applied to the elements, or “features, of the vector.

ML processor(s) 102, in training a machine learning model (e.g., deep neural network), iteratively generates model parameters (e.g., weights) that are subsequently used for inferencing with the machine learning model. Once the machine learning model converges or achieves a predetermined level of predictive accuracy, the model parameters need to be available for subsequent inferencing with the machine learning model. Nonvolatile storage medium 104 is capable of persistently storing the weights and other machine learning data (e.g., machine learning operational instructions). Once ML processor(s) 102 have trained a machine learning model and the model parameters are persistently stored in nonvolatile storage medium 104, the parameters are usable for inferencing with the now-trained machine learning model.

NVS controller 106 is capable of reading data from and writing data to nonvolatile storage medium 104. The read and write operations may be initiated by node controller 110 and/or ML processor(s) 102. The read and/or write operations also may be initiated by systems and processors external to AMLSN 100 as communicated to node controller 110, for example. Accordingly, NVS controller 106 is capable of managing transfers of machine learning data between ML processor(s) 102 and nonvolatile storage medium 104 using communication bus 108.

If ML processor(s) 102 train a machine learning model, NVS controller 106 is capable of executing memory-write operations to persistently store machine learning data (e.g., weights) generated by the ML processor(s) in nonvolatile storage medium 104. If ML processor(s) 102 perform an inferencing task using a trained machine learning model, then NVS controller 106 is capable of executing memory-read operations to obtain for the ML processor(s) the model parameters and/or other persistently stored machine learning data needed from nonvolatile storage medium 104.

Node controller 110 coupled with communication bus 108 is capable of executing processor-executable instructions. The instructions may include, for example, instructions to cause ML processor(s) 102 to execute matrix-vector multiplications, compute values generated by activation functions of a deep neural network, or other machine learning operations. Thus, the processor-executable instructions, when executed, cause ML processor(s) 102 to perform a machine learning task, including training a machine learning model or generating an inference (e.g., regression, classification) using an already trained model. Processor-executable instructions executed by node controller 110 include instructions specifying the specific type of machine learning model to be implemented by ML processor(s) 102 in performing the machine learning training or inferencing. The instructions for performing machine learning operations specific to the machine learning model may be ones persistently stored in nonvolatile storage medium 104, as described above.

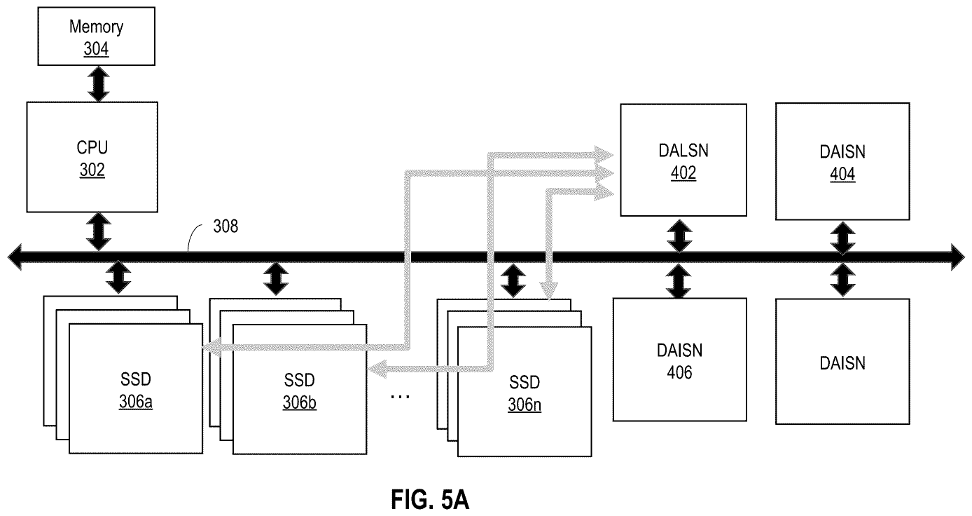

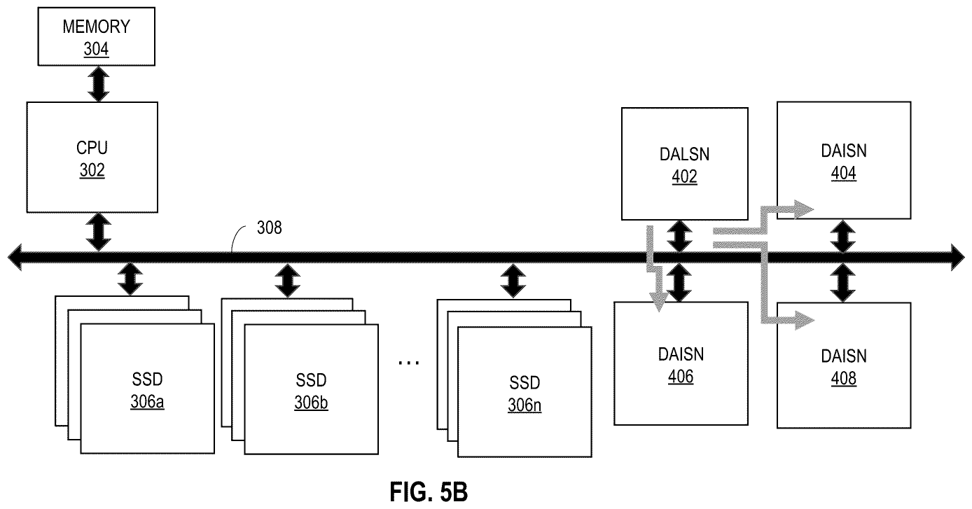

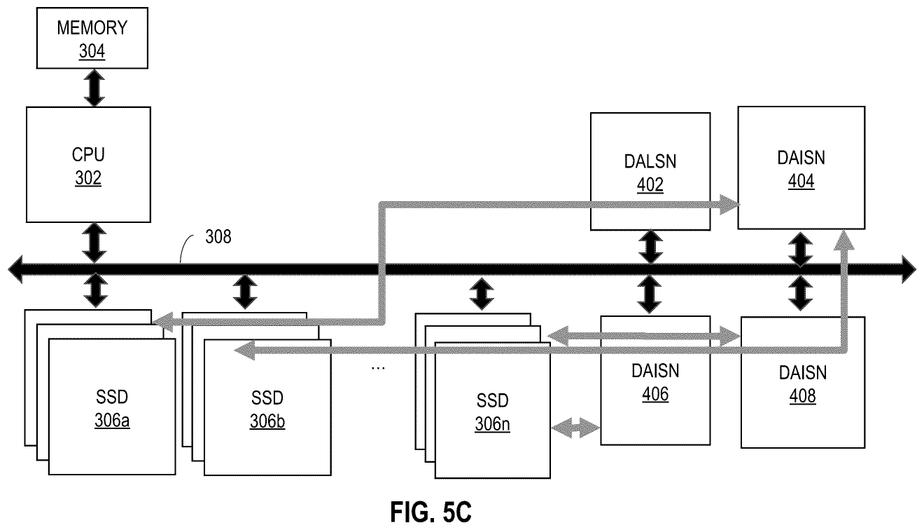

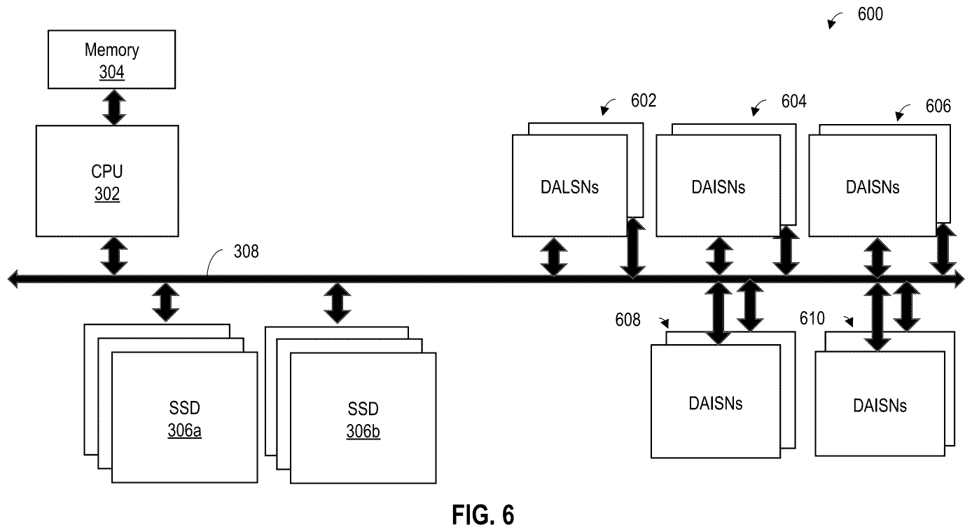

Node controller 110 is also capable of performing general management and other functions of the AMLSN 100. Moreover, AMLSN 100 is capable of interacting with external devices, such as a host processor, one or more other AMLSNs, and/or one or more solid-state drives (SSDs). The additional functions may include, for example, fetching and saving data to one or more other AMLSNs and/or one or more solid-state drives having flash memory (e.g., Single-Level Cell (SLC) NAND flash) to scale up the machine learning operations and/or a machine learning model, such as a deep neural network (FIGS. 5A-C, FIG. 6). Node controller 110, in certain embodiments, may perform load balancing, and/or conventional SSD-type data read and write operations within the AMLSN.

Memory 112 is capable of storing data that does not need to be persistently stored and is retained only as long as needed by ML processor(s) 102 in performing a specific machine learning task and/or as may be needed by node controller 110 performing task(s). Memory 112 is volatile memory (e.g., RAM) that may be accessed by node controller 110 and/or by ML processor(s) 102. Memory controller 114 operates as the gatekeeper and regulates read/write access by the respective processors to memory 112, which is runtime memory and stores various types of data. The particular operating system (OS) routine, application(s), and/or portions thereof executed by node controller 110, for example, may be stored in memory 112, placed there at boot as retrieved from nonvolatile storage medium 104.

Memory controller 114 is coupled to memory 112 and communication bus 108. Memory controller 114 manages data transfers between ML processor(s) 102, node controller 110, and memory 112. Memory controller 114, for example, may execute a memory-write operation to load and store in memory 112 processor-executable data comprising machine learning training examples that are used by ML processor(s) 102 to generate machine learning model parameters, which are then persistently stored in nonvolatile storage medium 104. Memory controller 114, for example, may execute a memory-read operation to convey from memory 112 to node controller 110 a stored set of processor executable instructions to initiate ML processor(s) 102's performance of machine learning operations using machine learning model parameters already persistently stored in and accessed from nonvolatile storage medium 104 via NVS controller 106.

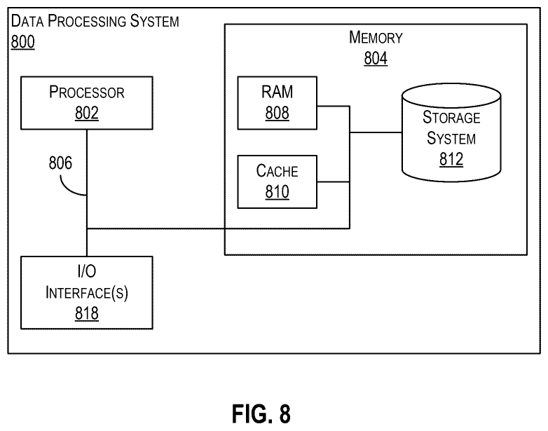

Direct memory access circuit 116 is capable of receiving processor-executable instructions and/or data from a host data processing system, such as data processing system 800 described with reference to FIG. 8 and/or from node controller 110. Data is transferred via host interface 118, which connects to a bus of the host data processing system with drive connector 120. In certain embodiments, direct memory access circuit 116 handles the transfer of data between AMLSN 100 and the host data processing system by direct access to the host data processing system's memory and by managing the data transfers. In certain embodiments, direct memory access circuit 116 handles data transfers between nonvolatile storage medium 104 and memory 112. Operatively, in certain arrangements, direct memory access circuit 116 may receive processor-executable instructions and/or data (e.g., training examples) from the host data processing system to facilitate AMLSN 100's performing machine learning operations in training a machine learning model. In other arrangements, direct memory access circuit 116 may convey output generated by AMLSN 100's performing machine learning operations to generate an inference with a trained machine learning model.

Notably, in each of the example scenarios described—both with respect to machine learning training and inferencing—the machine learning tasks are performed autonomously by AMLSN 100. That is, there is little or no involvement with the host data processing system. A processor executable instruction may be received by AMLSN 100 via the host data processing system bus, if for example the host provides the conduit for instructing that certain machine learning operations (e.g., training or inferencing) be performed. Training data may be received by AMLSN 100 from the host data processing system memory or inferencing results (e.g., regression or classification) may be conveyed from AMLSN 100 to the host for presenting to a user. Beyond that, however, there is little involvement with the host data processing system, as the essential machine learning operations are performed wholly by and within AMLSN 100. In one or more embodiments, the host data processing system CPU may perform the role of “orchestrator” to signal what machine learning tasks AMLSN 100 is to perform using which machine learning model and where training data may be found and/or where inferencing results should be conveyed but does nothing more with respect to the specific machine learning task. The performance of machine learning may be wholly autonomous, e.g., entirely self-contained, to AMLSN 100. One of the significant technical advantages is that the memory bottleneck problem in which processing with a host CPU requires that data be repeatedly read from and written to the memory—especially problematic with machine learning given the extremely large data requirements of machine learning—is significantly mitigated.

Host interface 118 may be implemented as any of a variety of available and/or known interfaces. For example, host interface 118 may be implemented as a Serial Advanced Technology Attachment interface, a Peripheral Component Interconnect Express (PCIe) interface, or as Non-Volatile Memory Express (NVMe) interface. Drive connector 120 may be implemented as any of a variety of known connectors, e.g., physical connectors, and may complement the particular type of interface used. AMLSN 100 itself may have different form factors such as that of a 2.5-inch solid-state drive (SSD) (using SATA interface), that of the M.2 SSD, PCIe Add-in Card (AIC) (using the PCIe interface), or other form factor.

In one or more embodiments, AMLSN 100 may be implemented as a data storage node (e.g., SSD) that is augmented, or endowed, with machine learning capabilities provided by the inclusion of dedicated processors for performing machine learning operations. Other devices or systems may issue read and/or write requests to AMLSN 100 that are unrelated to machine learning. Node controller 110 is capable of handling the read and/or write requests as well as any other tasks performed in connection with machine learning and/or performing load balancing between machine learning operations and conventional data storage operations.

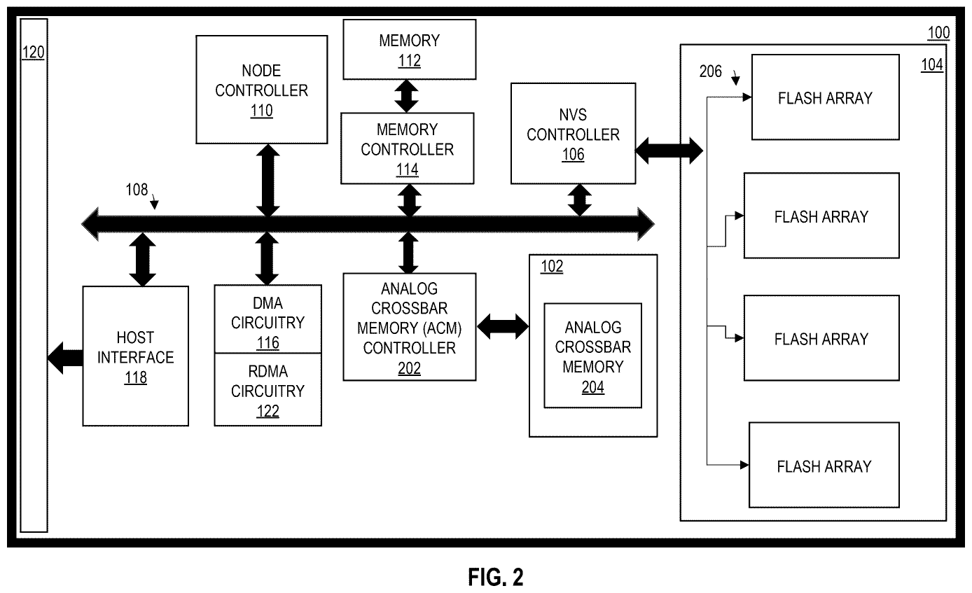

FIG. 2 illustrates another example architecture of AMLSN 100, according to certain other embodiments. Illustratively, AMLSN 100 in FIG. 2 also includes one or more ML processors 102, nonvolatile storage medium 104, NVS controller 106, communication bus 108, node controller 110, memory 112, memory controller 114, direct memory access circuit 116, host interface 118, drive connector 120, and RDMA circuitry 122. AMLSN 100 additionally includes analog crossbar memory (ACM) controller 202. ACM controller 202 manages data transfers with respect to ML processor(s) 102, which mitigates the internal memory bottleneck problem with respect to communication bus 108. As illustrated, ACM controller 202 connects to ML processor(s) 102, which, in the example of FIG. 2, includes or is implemented as analog crossbar memory 204. ACM controller 202 is only needed with embodiments in which ML processor(s) 102 are implemented in or include one or more analog crossbar memories.

Analog crossbar memory 204 comprises a grid of horizontal and vertical conductive lines whose intersections each provide a memristor (resistive memory). In certain embodiments, analog crossbar memory 204 comprises analog crossbar multiplication memory layers. The conductance value of each memristor represents elements of a matrix. Summing currents that are generated in response to applied voltages representing a vector produces an output corresponding to multiplication of the matrix by the vector. In creating the output of a deep neural network with analog crossbar memory 204, the output generated by summing the currents may be processed through an activation function implemented as part of ML processor(s) 102, using either analog or digital circuitry. Because analog crossbar memory 204 operates in the analog domain albeit primarily on data in the digital domain, data transfers between memory 112 and analog crossbar memory 204 may require conversion from one domain to another. The conversion may be performed by circuitry integrated into dedicated controller 202 or directly in analog crossbar memory 204.

Illustratively in FIG. 2, nonvolatile storage medium 104 is implemented with flash arrays 206. In certain embodiments, flash arrays 206 are NAND flash arrays built from NAND (Not AND) logic gates. Although nonvolatile storage medium 104 may be implemented with other types of flash memory, NAND flash arrays provide the technical advantages of high-density nonvolatile storage and relatively rapid read/write capabilities. It should be appreciated that the nonvolatile storage medium 104 of FIG. 1 may be implemented as described herein in connection with FIG. 2.

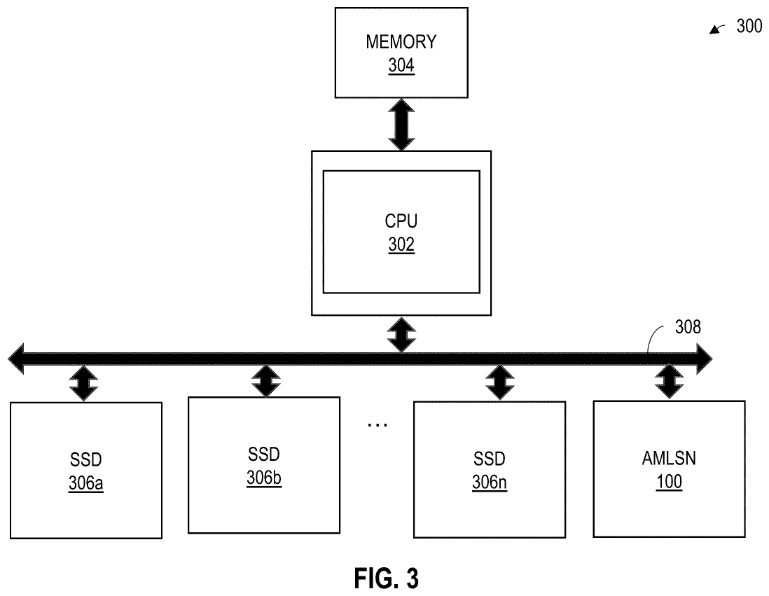

FIG. 3 illustrates machine learning system 300, which combines a data processing system's CPU 302 and memory 304 (e.g., a host data processing system or host system) with AMLSN 100 and one or more solid-state drives (SSDs) illustrated by SSDs 306a and 306b through 306n (where n is any positive integer). For purposes of discussion, CPU 302 is an example of a host processor while memory 304 is an example of a host memory. AMLSN 100 and SSDs 306a-306n are communicatively coupled via system bus 308 of the host data processing system. SSDs 306a-306n may store data comprising target examples to train a machine learning model, data comprising an input for which a machine learning model inference is desired, and/or data comprising processor-executable instructions to initiate AMLSN 100's performance of one or more machine learning tasks. CPU 302 need do little more than generate an instruction that initiates AMLSN 100's performing the one or more machine learning tasks and indicates which of SSDs 306a-306n to retrieve input data from or write output data to in performing the tasks. With respect to data transfers involving SSDs 306a-306n, AMLSN 100 utilizes RDMA circuitry 122. RDMA circuitry 122 enables direct memory access between AMLSN 100 and SSDs 306a-306n even though the AMLSN and SSDs are distinct devices. One of the significant technical advantages of system 300 is that it further isolates the host data processing system by eliminating the need for storing processor-executable instructions and machine learning data in memory 304. Another technical advantage is that processing demands on CPU 302 are reduced if not eliminated.

The example of FIG. 3 does not preclude implementations in which AMLSN 100, e.g., a single instance thereof, is used to perform machine learning functions such as training a machine learning model and/or performing inference using a machine learning model in a self-contained manner.

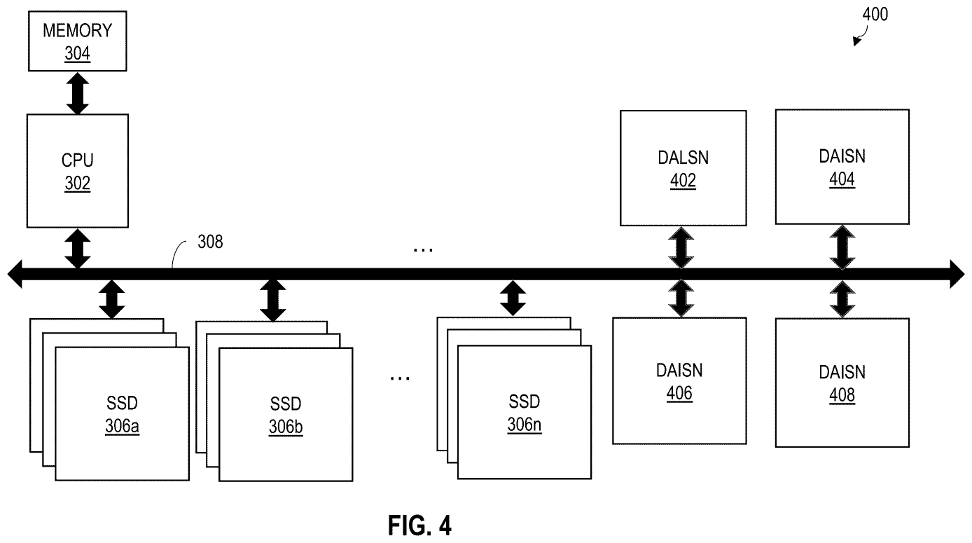

FIG. 4 illustrates another system 400, which combines CPU 302 and memory 304 of a host data processing system with solid-state drives (SSDs) 306a-306n. With system 400, however, a plurality of AMLSNs, denoted as deep autonomous learning storage node (DALSN) 402 and deep autonomous inferencing storage nodes (DAISNs) 404, 406, and 408, operate in conjunction with the other components of system 400. In the example of FIG. 4, the plurality of AMLSNs may differ according to function. DALSN 402 may implement a deep autonomous learning storage node that is capable of performing machine learning operations specific to training a machine learning model. DAISNs 404, 406, and 408 may be deep autonomous inferencing storage nodes capable of performing inferences using an already trained machine learning model. Each of DAISNs 404, 406 and 408 may implement a different type of machine learning model, such as a convolutional versus a recurrent neural network, for example. In the examples, any machine learning operations may be performed by the ML processor(s) 102 within the respective devices 402, 404, 406, and/or 408.

In certain embodiments, DALSN 402 and DAISNs 404, 406, and 408 may be preconfigured when manufactured but need not be. In other embodiments, DALSN 402 and DAISNs 404, 406, and 408 may be configured when deployed within a host data processing system or network. That is, as already noted, an AMLSN 100 generally may be switched between tasks and thus may be allocated to either training a machine learning model or generating inferences using a trained machine learning model. If one task is needed more than another, the function of the AMLSN 100 may be reallocated accordingly to perform a currently needed task, whether training or inferencing. For example, the host system need only send instructions and/or data to the AMLSN 100 to reallocate the AMLSN 100 at runtime to switch from inference to training or vice versa based on current computing requirements and/or needs. Moreover, as also noted, a collection of networked AMLSNs may grow with the addition of newly added AMLSNs and/or SSDs to accommodate different demands for specific machine learning tasks.

Segmenting the AMLSNs according to function provides technical advantages, including tiering. That is, different analog arrays (e.g., analog crossbar memory) and persistent storage media may be used to implement the AMLSNs depending on the specific function of each. Given the quantity of data involved in both machine learning and inferencing, bandwidth is typically important to both functions. Latency is relatively more important for inferencing, though, given that once a model is trained and put into operation, there is tendency to value how quickly a regression or classification is generated with the model. Training is typically a longer process in which accuracy may be as, or more, important than latency. Thus, for example, DALSNs may be configured using slower or higher latency nonvolatile storage mediums, while DAISNs may be configured using low-latency nonvolatile storage mediums. For purposes of illustration, less expensive but relatively slower 1-bit per cell NANDs may be used as nonvolatile storage mediums 104 in combination with static random-access memory (SRAM) as ML processor(s) 102 may be used to implement DALSNs. By contrast, for reduced latency, albeit at a cost, DAISNs may be implemented with 4-bit quad-level cell (QLC) NANDs as nonvolatile storage mediums 104 in combination with analog array elements implemented with Spin-Transfer Torque Magnetic Random-Access Memory (SST-MRAM, Resistive Random Access Memory (RRAM), and/or Phase-Change Memory (PCM)) as ML processors 102.

FIGS. 5A, 5B, and 5C illustrate combined autonomous learning and inferencing using DALSN 402 and DAISNs 404, 406, and 408. FIG. 5A illustrates a peer-to-peer (P2P) transfer of learning data between DALSN 402 and SSDs 306a-306n. For example, DALSN 402 may receive a request for implementation of a machine learning function from CPU 302. CPU 302 may indicate to DALSN 402 that data for performing functions located in SSDs 306a-306n. Node controller 110 of DALSN 402 may schedule RDMA circuitry 122 to retrieve any needed data from SSDs 306a-306n. Node controller 110 also may provide instructions to ML processor(s) 102 therein to begin the machine learning function. In this regard, ML processor(s) 102 may operate under control or supervision of node controller 110. Appreciably, data needed to perform the machine learning function may be fetched from SSDs 306a-306n and stored within nonvolatile storage medium 104 of DALSN 402 so that the needed data is locally accessible. In addition, or as an alternative, to consuming data fetched from SSDs 306a-306n, DALSN 402 may save data to the SSDs, for example, such as stateful information or as part of a cache in training a machine learning model. Accordingly, in some embodiments, one or more of the SSDs 306a-306n comprises NAND flash memory (e.g., Single-Level Cell (SLC) NAND flash memory) and may be used to pre-fetch and cache a dataset for training the machine learning model.

FIG. 5B illustrates P2P transfer of machine learning model parameters from DALSN 402 to DAISNs 404, 406, and 408. For example, DALSN 402 may receive an instruction from CPU 302 to convey a machine learning model trained by DALSN 402 to one or more of DAISNs 404, 406, and 408. DALSN 402 may have trained the machine learning model using the data CPU 302 indicated was located in SSDs 306a-306n. Node controller 110 of DALSN 402 may schedule RDMA circuitry 122 to convey the machine learning model to the DAISN(s) indicated by CPU 302. Appreciably, data needed to implement the machine learning model (e.g., model weights, activation functions) may be fetched by DALSN 402 from nonvolatile storage medium 104. Note DALSN 402, depending on instructions received from CPU 302 may train a different machine learning model for each of DAISNs 404, 406, and 408 individually.

FIG. 5C illustrates P2P transfer of inferencing data between DAISNs 404, 406, and 408 and SSDs 306a-306n. Data conveyed to DALSN 402 from one or more of SSDs 306a-306n may include one or more sets of training examples for training one or more specific machine learning models according to the instructions received from CPU 302. Data conveyed from DAISNs 404, 406, and 408 to one or more of SSDs 306a-306n may include regression values or classification labels determined from the inferences generated by the DAISNs. In each instance, a technical advantage is the P2P transfers, which mitigate the memory bottleneck problem for CPU 302 and memory 304 of the host data processing system notwithstanding the likely very large quantity of data transferred with respect to both training the respective machine learning models and generating inferences using the models once trained.

Another technical advantage is composability, according to which a machine learning model may be constructed from multiple AMLSNs and subsequently expanded simply by adding additional ones. In one aspect, composability enables the construction of deep neural networks in which the deep neural networks are composed of clusters of AMLSNs. Each AMLSN of a cluster may form one layer (or several sub-layers) of a deep neural network. The output of one AMLSN of the cluster may be fed into a succeeding one, the final AMLSN being, or including, the output layer of the deep neural network.

FIG. 6 illustrates a set of deep learning neural networks 600. Each of the deep learning networks is composed of a cluster of AMLSNs, the clusters comprising DALSN 602 and DAISNs 604, 606, and 608. In other embodiments, a single cluster of AMLSNs may form a deep neural network that is both trained and subsequently used for inferencing. One of the technical advantages of composability of AMLSNs is the ability to scale up an existing deep neural network by merely adding additional AMLSNs to the cluster forming the deep neural network.

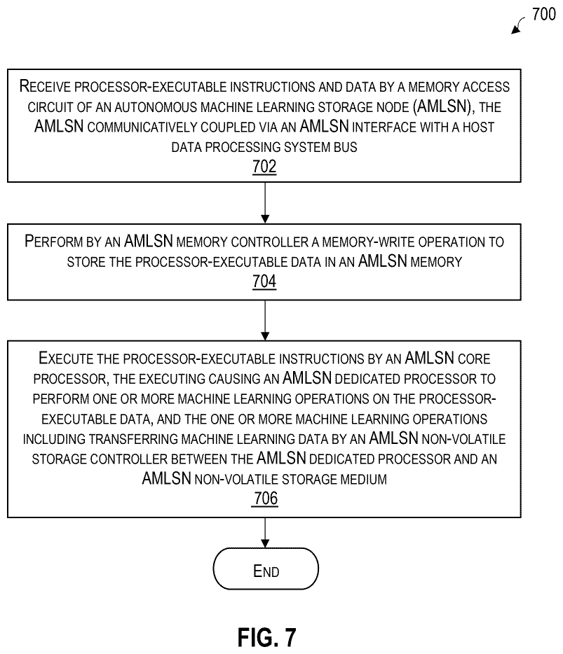

FIG. 7 is a method 700 of implementing machine learning using an AMLSN, such as AMLSN 100 as described. In block 702, an AMLSN receives processor-executable instructions and data. The processor-executable instructions and data may be received by a direct memory access circuit, such as direct memory access circuit 116 of the AMLSN. The direct memory access circuit of the AMLSN is communicatively coupled via a host interface, such as host interface 118, with a host data processing system bus, such as host data processing system bus 308 in FIGS. 3-5C. In block 704, a memory controller performs a memory-write operation to store the processor-executable data in a memory. In block 706, a node controller such a node controller 110 executes the processor-executable instructions. Executing the processor-executable instructions cause an ML processor to perform one or more machine learning operations on the processor-executable data. The one or more machine learning operations are performed by one or more machine learning processors such ML processor(s) 102 and include transferring machine learning data by a nonvolatile storage controller (e.g., NVS controller 106) between the ML processor(s) and the nonvolatile storage medium.

In some embodiments, the node controller, such as node controller 110 of AMLSN 100, is capable of managing workload. If the AMLSN performs conventional data storage and machine learning, the node controller may prioritize workloads over one another based on internal data congestion and/or flash memory I/O capabilities. A host data processing system with which the AMLSN is coupled may provide, for example, provide a priority ranking of jobs performed (whether data storage or machine learning operations). The node controller may interrupt one job or allow a higher-priority job to continue executing based on the ranking, and then allow the other job to continue. Training a machine learning model, for example, need not always have real-time performance, in which case the training may be paused in order to fetch data from or write data to the nonvolatile storage medium, such as NAND flash arrays 206 (FIG. 2).

The one or more machine learning operations may train a machine learning model and generate parameters for the machine learning model. In transferring machine learning data, the NVS controller may perform one or more write operations to store the parameters in the nonvolatile storage medium for subsequent tasks using the machine learning model.

The one or more machine learning operations may generate a machine learning model inference using previously generated machine learning model parameters. In the transferring machine learning data, the NVS controller may perform one or more read operations to transfer the previously generated machine learning model parameters from the nonvolatile storage medium to the ML processor(s). The ML processor generates an inference using the previously generated machine learning model parameters.

In certain embodiments, the memory access controller is or includes a remote direct memory access (RDMA) controller. The receiving of at least one of the processor-executable instructions and processor-executable data may include the RDMA controller establishing a connection with at least one solid-state drive also communicatively coupled with the host data processing system bus and transferring at least one of the processor-executable instructions and processor-executable data via the host data processing system bus from the at least one solid-state drive to the nonvolatile storage medium.

In certain embodiments in which the direct memory access controller is or includes the RDMA controller, the one or more machine learning operations generate a trained machine learning model. The RDMA controller may use a connection with another AMLSN communicatively coupled with the host data processing system bus to transfer the trained machine learning model to the other AMLSN via the host data processing system bus.

The AMLSN in certain embodiments may be clustered with one or more other AMLSNs to form a composable deep neural network. The composable deep neural network is composed of individual AMLSNs clustered together to form the layers of the deep neural network. The composable deep neural network may be expanded by adding additional AMLSNs to correspond to adding layers to the deep neural network. The composable deep neural network is trained by transferring data between the AMLSN and at least one or more other AMLSNs. The data transfer may be a P2P transfer between the AMLSN and at least one or more other AMLSNs. The data transferred between the AMLSN and at least one or more other AMLSNs is generated by machine learning operations performed by the AMLSN and at least one or more other AMLSNs.

In still other embodiments in which the AMLSN is clustered with one or more other AMLSNs to form a composable deep neural network, an inference may be generated by the composable deep neural network. The composable deep neural network generates the inference based on data transferred between the AMLSN and at least one or more other AMLSNs. The data transfer may be a P2P transfer between the AMLSN and at least one or more other AMLSNs. The data transferred between the AMLSN and at least one or more other AMLSNs is generated by machine learning operations performed by the AMLSN and at least one or more other AMLSNs.

FIG. 8 illustrates an example implementation of a data processing system 800. As defined herein, the term “data processing system” means one or more hardware systems configured to process data, each hardware system including at least one processor and memory, wherein the processor is programmed with computer-readable instructions that, upon execution, initiate operations. Data processing system 800 can include a processor 802, a memory 804, and a bus 806 that couples various system components including memory 804 to processor 802.

Processor 802 may be implemented as one or more processors. In an example, processor 802 is implemented as a central processing unit CPU. Processor 802 is an example of a host processor as discussed within this disclosure. Processor 802 may be implemented as one or more circuits capable of carrying out instructions contained in program code. The circuit may be an integrated circuit or embedded in an integrated circuit. Processor 802 may be implemented using a complex instruction set computer architecture (CISC), a reduced instruction set computer architecture (RISC), a vector processing architecture, or other known architectures. Example processors include, but are not limited to, processors having a 8×6 type of architecture (IA-32, IA-64, etc.), Power Architecture, ARM processors, and the like.

Bus 806 represents one or more of any of a variety of communication bus structures. By way of example, and not limitation, bus 806 may be implemented as a Peripheral Component Interconnect Express (PCIe) bus. Data processing system 800 typically includes a variety of computer system readable media. Such media may include computer-readable volatile and non-volatile media and computer-readable removable and non-removable media.

Memory 804 can include computer-readable media in the form of volatile memory, such as random-access memory (RAM) 808 and/or cache memory 810. Data processing system 800 also can include other removable/non-removable, volatile/non-volatile computer storage media. By way of example, storage system 812 can be provided for reading from and writing to a non-removable, non-volatile magnetic and/or solid-state media (not shown and typically called a “hard drive”). Although not shown, a magnetic disk drive for reading from and writing to a removable, non-volatile magnetic disk, and an optical disk drive for reading from or writing to a removable, non-volatile optical disk such as a CD-ROM, DVD-ROM or other optical media can be provided. In such instances, each can be connected to bus 806 by one or more data media interfaces. Memory 804 is an example of at least one computer program product.

Memory 804 is capable of storing computer-readable program instructions that are executable by processor 802. For example, the computer-readable program instructions can include an operating system, one or more application programs, other program code, and program data. The computer-readable program instructions may implement any of the different examples of performing machine learning operations described herein. Processor 802, in executing the computer-readable program instructions, is capable of performing the various operations described herein that are attributable to a computer. It should be appreciated that data items used, generated, and/or operated upon by data processing system 800 are functional data structures that impart functionality when employed by data processing system 800. As defined within this disclosure, the term “data structure” means a physical implementation of a data model's organization of data within a physical memory. As such, a data structure is formed of specific electrical or magnetic structural elements in a memory. A data structure imposes physical organization on the data stored in the memory as used by an application program executed using a processor. Examples of data structures include images and meshes.

Data processing system 800 may include one or more Input/Output (I/O) interfaces 818 communicatively linked to bus 806. I/O interface(s) 818 allow data processing system 800 to communicate with one or more external devices and/or communicate over one or more networks such as a local area network (LAN), a wide area network (WAN), and/or a public network (e.g., the Internet). Examples of I/O interfaces 818 may include, but are not limited to, network cards, modems, network adapters, hardware controllers, etc. Examples of external devices also may include devices that allow a user to interact with data processing system 800 (e.g., a display, a keyboard, a microphone for receiving or capturing audio data, speakers, and/or a pointing device). In the example data processing system 800 is capable of communicating with one or more AMLSNs 100 via I/O interfaces 818. For example, bus 308 may be considered an extension or continuation of bus 806 illustrated in FIG. 8 to which the AMLSNs 100 and/or other nodes such as SSDs are connected.

Data processing system 800 is only one example implementation. Data processing system 800 can be practiced as a standalone device (e.g., as a user computing device or a server, as a bare metal server), in a cluster (e.g., two or more interconnected computers), or in a distributed cloud computing environment (e.g., as a cloud computing node) where tasks are performed by remote processing devices that are linked through a communications network. In a distributed cloud computing environment, program modules may be located in both local and remote computer system storage media including memory storage devices.

The example of FIG. 8 is not intended to suggest any limitation as to the scope of use or functionality of example implementations described herein. Data processing system 800 is an example of computer hardware that is capable of performing the various operations described within this disclosure. In this regard, data processing system 800 may include fewer components than shown or additional components not illustrated in FIG. 8 depending upon the particular type of device and/or system that is implemented. The particular operating system and/or application(s) included may vary according to device and/or system type as may the types of I/O devices included. Further, one or more of the illustrative components may be incorporated into, or otherwise form a portion of, another component. For example, a processor may include at least some memory.

As used herein, the term “cloud computing” refers to a computing model that facilitates convenient, on-demand network access to a shared pool of configurable computing resources such as networks, servers, storage, applications, ICs (e.g., programmable ICs) and/or services. These computing resources may be rapidly provisioned and released with minimal management effort or service provider interaction. Cloud computing promotes availability and may be characterized by on-demand self-service, broad network access, resource pooling, rapid elasticity, and measured service.

The example of FIG. 8 is not intended to suggest any limitation as to the scope of use or functionality of example implementations described herein. Data processing system 800 is an example of computer hardware that is capable of performing the various operations described within this disclosure. In this regard, data processing system 800 may include fewer components than shown or additional components not illustrated in FIG. 8 depending upon the particular type of device and/or system that is implemented. The particular operating system and/or application(s) included may vary according to device and/or system type as may the types of I/O devices included. Furthermore, one or more of the illustrative components may be incorporated into, or otherwise form a portion of, another component. For example, a processor may include at least some memory.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

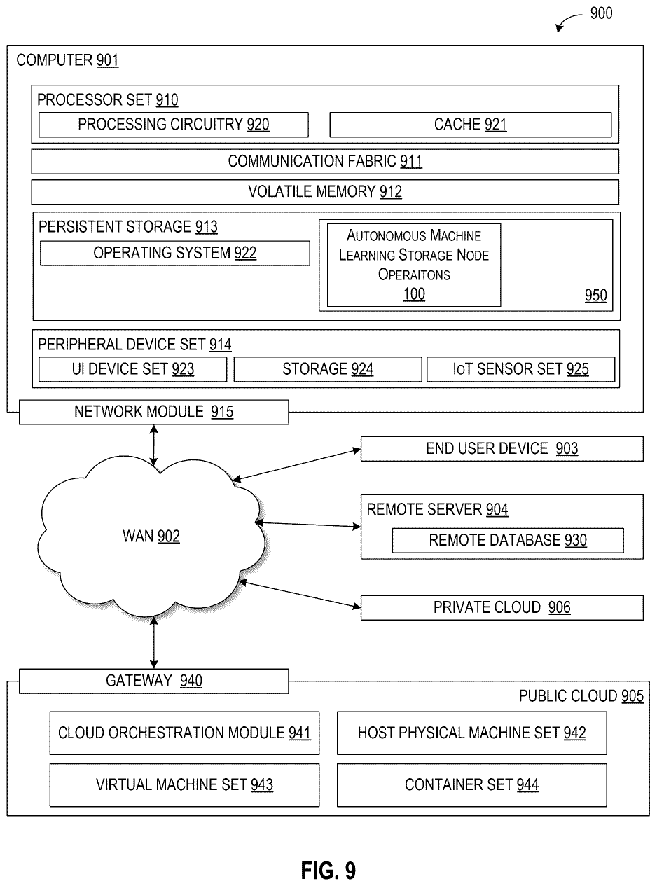

Referring to FIG. 9, computing environment 900 contains an example of an environment for the execution of at least some of the computer code involved in performing the inventive methods, such as performing machine learning by an AMLSN as described in FIGS. 1-8, as illustrated at block 950. In addition to block 950, computing environment 900 includes, for example, computer 901, wide area network (WAN) 902, end user device (EUD) 903, remote server 904, public cloud 905, and private cloud 906. In this embodiment, computer 901 includes processor set 910 (including processing circuitry 920 and cache 921), communication fabric 911, volatile memory 912, persistent storage 913 (including operating system 922 and block 950, as identified above), peripheral device set 914 (including user interface (UI) device set 923, storage 924, and Internet of Things (IoT) sensor set 925), and network module 915. Remote server 904 includes remote database 930. Public cloud 905 includes gateway 940, cloud orchestration module 941, host physical machine set 942, virtual machine set 943, and container set 944.

Computer 901 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 930. As is well understood in the art of computer technology, and depending upon the technology, performance of a computer-implemented method may be distributed among multiple computers and/or between multiple locations. On the other hand, in this presentation of computing environment 900, detailed discussion is focused on a single computer, specifically computer 901, to keep the presentation as simple as possible. Computer 901 may be located in a cloud, even though it is not shown in a cloud in FIG. 9. On the other hand, computer 901 is not required to be in a cloud except to any extent as may be affirmatively indicated.

Processor set 910 includes one, or more, computer processors of any type now known or to be developed in the future. Processing circuitry 920 may be distributed over multiple packages, for example, multiple, coordinated integrated circuit chips. Processing circuitry 920 may implement multiple processor threads and/or multiple processor cores. Cache 921 is memory that is located in the processor chip package(s) and is typically used for data or code that should be available for rapid access by the threads or cores running on processor set 910. Cache memories are typically organized into multiple levels depending upon relative proximity to the processing circuitry. Alternatively, some, or all, of the cache for the processor set may be located “off chip.” In some computing environments, processor set 910 may be designed for working with qubits and performing quantum computing.

Computer readable program instructions are typically loaded onto computer 901 to cause a series of operational steps to be performed by processor set 910 of computer 901 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 921 and the other storage media discussed below. The program instructions, and associated data, are accessed by processor set 910 to control and direct performance of the inventive methods. In computing environment 900, at least some of the instructions for performing the inventive methods may be stored in block 950 in persistent storage 913.

Communication fabric 911 is the signal conduction paths that allow the various components of computer 901 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 912 is any type of volatile memory now known or to be developed in the future. Examples include dynamic type random access memory (RAM) or static type RAM. Typically, the volatile memory is characterized by random access, but this is not required unless affirmatively indicated. In computer 901, the volatile memory 912 is located in a single package and is internal to computer 901, but, alternatively or additionally, the volatile memory may be distributed over multiple packages and/or located externally with respect to computer 901.

Persistent storage 913 is any form of non-volatile storage for computers that is now known or to be developed in the future. The non-volatility of this storage means that the stored data is maintained regardless of whether power is being supplied to computer 901 and/or directly to persistent storage 913. Persistent storage 913 may be a read only memory (ROM), but typically at least a portion of the persistent storage allows writing of data, deletion of data and re-writing of data. Some familiar forms of persistent storage include magnetic disks and solid-state storage devices. Operating system 922 may take several forms, such as various known proprietary operating systems or open-source Portable Operating System Interface type operating systems that employ a kernel. The code included in block 950 typically includes at least some of the computer code involved in performing the inventive methods.

Peripheral device set 914 includes the set of peripheral devices of computer 901. Data communication connections between the peripheral devices and the other components of computer 901 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 923 may include components such as a display screen, speaker, microphone, wearable devices (such as goggles and smart watches), keyboard, mouse, printer, touchpad, game controllers, and haptic devices. Storage 924 is external storage, such as an external hard drive, or insertable storage, such as an SD card. Storage 924 may be persistent and/or volatile. In some embodiments, storage 924 may take the form of a quantum computing storage device for storing data in the form of qubits. In embodiments where computer 901 is required to have a large amount of storage (e.g., where computer 901 locally stores and manages a large database) then this storage may be provided by peripheral storage devices designed for storing very large amounts of data, such as a storage area network (SAN) that is shared by multiple, geographically distributed computers. IoT sensor set 925 is made up of sensors that can be used in Internet of Things applications. For example, one sensor may be a thermometer and another sensor may be a motion detector.

Network module 915 is the collection of computer software, hardware, and firmware that allows computer 901 to communicate with other computers through WAN 902. Network module 915 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 915 are performed on the same physical hardware device. In other embodiments (e.g., embodiments that utilize software-defined networking (SDN)), the control functions and the forwarding functions of network module 915 are performed on physically separate devices, such that the control functions manage several different network hardware devices. Computer readable program instructions for performing the inventive methods can typically be downloaded to computer 901 from an external computer or external storage device through a network adapter card or network interface included in network module 915.

WAN 902 is any wide area network (e.g., the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

EUD 903 is any computer system that is used and controlled by an end user (e.g., a customer of an enterprise that operates computer 901), and may take any of the forms discussed above in connection with computer 901. EUD 903 typically receives helpful and useful data from the operations of computer 901. For example, in a hypothetical case where computer 901 is designed to provide a recommendation to an end user, this recommendation would typically be communicated from network module 915 of computer 901 through WAN 902 to EUD 903. In this way, EUD 903 can display, or otherwise present, the recommendation to an end user. In some embodiments, EUD 903 may be a client device, such as thin client, heavy client, mainframe computer, desktop computer and so on.

Remote server 904 is any computer system that serves at least some data and/or functionality to computer 901. Remote server 904 may be controlled and used by the same entity that operates computer 901. Remote server 904 represents the machine(s) that collect and store helpful and useful data for use by other computers, such as computer 901. For example, in a hypothetical case where computer 901 is designed and programmed to provide a recommendation based on historical data, then this historical data may be provided to computer 901 from remote database 930 of remote server 904.

Public cloud 905 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 905 is performed by the computer hardware and/or software of cloud orchestration module 941. The computing resources provided by public cloud 905 are typically implemented by virtual computing environments that run on various computers making up the computers of host physical machine set 942, which is the universe of physical computers in and/or available to public cloud 905. The virtual computing environments (VCEs) typically take the form of virtual machines from virtual machine set 943 and/or containers from container set 944. It is understood that these VCEs may be stored as images and may be transferred among and between the various physical machine hosts, either as images or after instantiation of the VCE. Cloud orchestration module 941 manages the transfer and storage of images, deploys new instantiations of VCEs and manages active instantiations of VCE deployments. Gateway 940 is the collection of computer software, hardware, and firmware that allows public cloud 905 to communicate through WAN 902.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 906 is similar to public cloud 905, except that the computing resources are only available for use by a single enterprise. While private cloud 906 is depicted as being in communication with WAN 902, in other embodiments a private cloud may be disconnected from the internet entirely and only accessible through a local/private network. A hybrid cloud is a composition of multiple clouds of different types (e.g., private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 905 and private cloud 906 are both part of a larger hybrid cloud.

The terminology used herein is for the purpose of describing particular embodiments only and is not intended to be limiting. Notwithstanding, several definitions that apply throughout this document now will be presented.

As defined herein, the singular forms “a,” “an,” and “the” are intended to include the plural forms as well, unless the context clearly indicates otherwise.

As defined herein, the terms “at least one,” “one or more,” and “and/or,” are open-ended expressions that are both conjunctive and disjunctive in operation unless explicitly stated otherwise. For example, each of the expressions “at least one of A, B, and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without user intervention.

As defined herein, the term “computer readable storage medium” means a storage medium that contains or stores program code for use by or in connection with an instruction execution system, apparatus, or device. As defined herein, a “computer readable storage medium” is not a transitory, propagating signal per se. A computer readable storage medium may be, but is not limited to, an electronic storage device, a magnetic storage device, an optical storage device, an electromagnetic storage device, a semiconductor storage device, or any suitable combination of the foregoing. The different types of memory, as described herein, are examples of a computer readable storage media. A non-exhaustive list of more specific examples of a computer readable storage medium may include: a portable computer diskette, a hard disk, a random-access memory (RAM), a read-only memory (ROM), an erasable programmable read-only memory (EPROM or Flash memory), a static random-access memory (SRAM), a portable compact disc read-only memory (CD-ROM), a digital versatile disk (DVD), a memory stick, a floppy disk, or the like.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” “one or more embodiments,” or similar language mean that a particular feature, structure, or characteristic described in connection with the embodiment is included in at least one embodiment described within this disclosure. Thus, appearances of the phrases “in one embodiment,” “in an embodiment,” “in one or more embodiments,” and similar language throughout this disclosure may, but do not necessarily, all refer to the same embodiment. The terms “embodiment” and “arrangement” are used interchangeably within this disclosure.

As defined herein, the term “processor” means at least one hardware circuit. The hardware circuit may be configured to carry out instructions contained in program code. The hardware circuit may be an integrated circuit. Examples of a processor include, but are not limited to, a CPU, an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “real-time” means a level of processing responsiveness that a user or system senses as sufficiently immediate for a particular process or determination to be made, or that enables the processor to keep up with some external process.

As defined herein, the term “responsive to” and similar language as described above, e.g., “if,” “when,” or “upon,” mean responding or reacting readily to an action or event. The response or reaction is performed automatically. Thus, if a second action is performed “responsive to” a first action, there is a causal relationship between an occurrence of the first action and an occurrence of the second action. The term “responsive to” indicates the causal relationship.

The term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc. may be used herein to describe various elements. These elements should not be limited by these terms, as these terms are only used to distinguish one element from another unless stated otherwise or the context clearly indicates otherwise.

A computer program product may include a computer readable storage medium (or media) having computer readable program instructions thereon for causing a processor to carry out aspects of the present invention. Within this disclosure, the term “program code” is used interchangeably with the term “computer readable program instructions.” Computer readable program instructions described herein may be downloaded to respective computing/processing devices from a computer readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations for the inventive arrangements described herein may be assembler instructions, instruction-set-architecture (ISA) instructions, machine instructions, machine dependent instructions, microcode, firmware instructions, or either source code or object code written in any combination of one or more programming languages, including an object-oriented programming language and/or procedural programming languages. Computer readable program instructions may specify state-setting data. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the computer readable program instructions by utilizing state information of the computer readable program instructions to personalize the electronic circuitry, in order to perform aspects of the inventive arrangements described herein.

Certain aspects of the inventive arrangements are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by computer readable program instructions, e.g., program code.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. In this way, operatively coupling the processor to program code instructions transforms the machine of the processor into a special-purpose machine for carrying out the instructions of the program code. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the operations specified in the flowchart and/or block diagram block or blocks.

The computer readable program instructions may also be loaded onto a computer, other programmable data processing apparatus, or other device to cause a series of operations to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the inventive arrangements. In this regard, each block in the flowcharts or block diagrams may represent a module, segment, or portion of instructions, which comprises one or more executable instructions for implementing the specified operations. In some alternative implementations, the operations noted in the blocks may occur out of the order noted in the figures. For example, two blocks shown in succession may be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts or carry out combinations of special purpose hardware and computer instructions.

The corresponding structures, materials, acts, and equivalents of all means or step plus function elements that may be found in the claims below are intended to include any structure, material, or act for performing the function in combination with other claimed elements as specifically claimed.

The description of the embodiments provided herein is for purposes of illustration and is not intended to be exhaustive or limited to the form and examples disclosed. The terminology used herein was chosen to explain the principles of the inventive arrangements, the practical application or technical improvement over technologies found in the marketplace, and/or to enable others of ordinary skill in the art to understand the embodiments disclosed herein. Modifications and variations may be apparent to those of ordinary skill in the art without departing from the scope and spirit of the described inventive arrangements. Accordingly, reference should be made to the following claims, rather than to the foregoing disclosure, as indicating the scope of such features and implementations.

What is claimed is:

1. A system, comprising:
a host processor;
a machine learning storage node coupled to the host processor, wherein the machine learning storage node comprises:
a node controller;
a nonvolatile storage medium;
one or more machine learning processors dedicated for performing machine learning operations; and
a communication bus coupled to the node controller, the nonvolatile storage medium, and the one or more machine learning processors;
wherein the one or more machine learning processors operate under control of the node controller to perform the machine learning operations using data accessed from the nonvolatile storage medium; and
wherein the node controller is capable of controlling operation of the one or more machine learning processors responsive to commands from the host processor.

2. The system of claim 1, further comprising:
at least one other machine learning storage node;
wherein the machine learning storage node and the at least one other machine learning storage node are capable of peer-to-peer transfers of data via a host bus.

3. The system of claim 2, wherein the machine learning storage node is capable of generating machine learning model parameters by performing the machine learning operations to train a machine learning model, and wherein the at least one other machine learning storage node is capable of generating inferences by performing machine learning operations using the machine learning model parameters.

4. The system of claim 2, wherein the at least one other machine learning storage node and the machine learning storage node comprise a composable deep neural network.

5. The system of claim 4, wherein the composable deep neural network is capable of machine learning based on the peer-to-peer transfers of data via the host bus.

6. The system of claim 4, wherein the composable deep neural network is capable of generating inferences based on the peer-to-peer transfers of data via the host bus.

7. The system of claim 4, wherein the composable deep neural network is scaled by adding at least one additional machine learning storage node that is capable of peer-to-peer transfers of data with the machine learning storage node and the at least one other machine learning storage node via the host bus.

8. A device, comprising:
a node controller;
a nonvolatile storage medium;
one or more machine learning processors dedicated for performing machine learning operations; and
a communication bus coupled to the node controller, the nonvolatile storage medium, and the one or more machine learning processors;
wherein the one or more machine learning processors operate under control of the node controller to perform the machine learning operations using data accessed from the nonvolatile storage medium.

9. The device of claim 8, wherein the one or more machine learning processors are dedicated for performing machine learning functions; and
wherein the node controller is capable of performing read and write operations on the nonvolatile storage medium responsive to requests from a host processor.

10. The device of claim 8, wherein the one or more machine learning processors comprise an analog crossbar memory capable of performing at least one of a matrix-vector multiplication, a matrix inversion, pseudoinverse generation, and generation of an eigenvector and corresponding eigenvalue.

11. The device of claim 8, wherein the one or more machine learning processors include one or more Graphics Processing Units (GPUs).

12. The device of claim 8, wherein the one or more machine learning processors include a Neural Processing Unit (NPU).

13. The device of claim 8, further comprising:
a remote direct memory access circuit capable of accessing data for use by the one or more machine learning processors from one or more other network-connected data storage nodes.

14. The device of claim 8, wherein the device operates as a peripheral device of a host processor.

15. A method, comprising:
storing machine learning data within a nonvolatile storage medium of a machine learning storage node, wherein the machine learning storage node includes a node controller and one or more machine learning processors; and
executing, under control of the node controller, machine learning operations by the one or more machine learning processors using data accessed from the nonvolatile storage medium;
wherein the one or more machine learning processors are dedicated to performing the machine learning operations.

16. The method of claim 15, wherein the one or more machine learning operations train a machine learning model by generating machine learning model parameters for the machine learning model, and further comprising:
storing the parameters within the nonvolatile storage.

17. The method of claim 15, wherein the one or more machine learning operations generate a machine learning model inference using previously generated machine learning model parameters, and further comprising:
accessing the previously generated machine learning model parameters from the nonvolatile storage.

18. The method of claim 15, wherein the machine learning storage node includes a remote direct memory access (RDMA) controller coupled with a data processing system bus, and further comprising:
accessing with the RDMA controller data from at least one solid-state drive also connected with the data processing system bus, the data providing input to the one or more machine learning processors for performing the machine learning operations.

19. The method of claim 15, wherein the machine learning storage node includes an RDMA controller coupled with a data processing system bus and forms, with at least one other machine learning storage node coupled with the data processing system bus, a composable deep neural network, and further comprising:
training the composable deep neural network by a transfer of data between the machine learning storage node and the at least one other machine learning storage node.

20. The method of claim 15, wherein the machine learning storage node includes an RDMA controller coupled with a data processing system bus and forms, with at least one other machine learning storage node coupled with the data processing system bus, a composable deep neural network, and further comprising:
generating an inference by the composable deep neural network based on a transfer of data between the machine learning storage node and the at least one other machine learning storage node.
